(19) United States
(12) Patent Application Publication
(10) Pub. No.: US 2026/0105038 A1
(43) Pub. Date: Apr. 16, 2026

(54) INDEX QUERY METHOD, APPARATUS, AND DEVICE BASED ON DATABASE

(71) Applicant: Beijing Volcano Engine Technology Co., Ltd., Beijing (CN)

(72) Inventors: Qianling Li, Beijing (CN); Heng Chen, Beijing (CN); Rui Shi, Beijing (CN)

(21) Appl. No.: 19/227,916

(22) Filed: Jun. 4, 2025

(30) Foreign Application Priority Data
Oct. 10, 2024 (CN) 202411412975.5

(51) Int. Cl. G06F 16/22; G06F 16/2453

(52) U.S. Cl. CPC G06F 16/2237; G06F 16/2453

(57) ABSTRACT

The present application discloses an index query method, apparatus, and device based on a database, wherein index optimization is performed for a read-only scenario. The method includes: determining a page identification corresponding to a target key in a data query request based on a hash value of the target key; obtaining a page index file corresponding to the page identification, wherein the page index file has a page index structure, the page index structure includes an entry array, a chunk bitmap and a length array, the entry array includes entry data of the page index file, and the entry data is sorted in an order of buckets to which the entry data belong and in an order of the entry data in the buckets; and querying, in the page index file, whether there is a value corresponding to the target key.

### CROSS-REFERENCE TO RELATED APPLICATION(S)

This application claims priority to Chinese Application No. 202411412975.5 filed in Oct. 10, 2024, the disclosures of which are incorporated herein by reference in their entireties.

### FIELD

The present application relates to the field of database technologies, and in particular, to an index query method, apparatus, and device based on a database.

### BACKGROUND

In a database, especially a distributed database, an index structure is crucial to a storage engine. Data that is not needed can be quickly filtered out through an index, and target data is found, so that the data query efficiency is improved.

A HashMap (Hash-based Map) or a HashTable (Hash table) is a Hash-based and highly efficient query structure that can search out a corresponding value based on a key, which also makes it an almost necessary data structure for each development language. There are many mature and efficient algorithm implementations for HashMap, and these implementations can usually provide general capabilities such as addition, deletion and query.

### SUMMARY

In view of this, embodiments of the present application provide an index query method, apparatus, and device based on a database.

To solve the above problem, the technical solution provided in the embodiments of the present application is as follows:

According to a first aspect, an embodiment of the present application provides an index query method based on a database. The method includes:
obtaining a data query request for a database, wherein the data query request includes a target key;
determining a page identification corresponding to the target key based on a hash value of the target key;
obtaining a page index file corresponding to the page identification, wherein the page index file has a page index structure, the page index structure includes an entry array, a chunk bitmap and a length array, the entry array includes entry data of the page index file, the entry data is sorted in an order of buckets to which the entry data belong and in an order of the entry data in the buckets, each piece of the entry data includes a key-value pair of an index, the chunk bitmap includes a first field and a second field corresponding to each chunk, the first field is used to save, using a first preset number of bits, state values of whether buckets forming the chunk are empty buckets, the second field is used to save a first number value of pieces of entry data included in all chunks before a current chunk, the length array includes unary coding of non-empty buckets, and each piece of the unary coding corresponds to a number of pieces of entry data included in one non-empty bucket; and
querying, in the page index file, whether there is a value corresponding to the target key.

According to a second aspect, an embodiment of the present application provides an index query apparatus based on a database. The apparatus includes:
a first obtaining unit, configured to obtain a data query request for a database, wherein the data query request includes a target key;
a first determining unit, configured to determine a page identification corresponding to the target key based on a hash value of the target key;
a second obtaining unit, configured to obtain a page index file corresponding to the page identification, wherein the page index file has a page index structure, the page index structure includes an entry array, a chunk bitmap and a length array, the entry array includes entry data of the page index file, the entry data is sorted in an order of buckets to which the entry data belong and in an order of the entry data in the buckets, each piece of the entry data includes a key-value pair of an index, the chunk bitmap includes a first field and a second field corresponding to each chunk, the first field is used to save, using a first preset number of bits, state values of whether buckets forming the chunk are empty buckets, the second field is used to save a first number value of pieces of entry data included in all chunks before a current chunk, the length array includes unary coding of non-empty buckets, and each piece of the unary coding corresponds to a number of pieces of entry data included in one non-empty bucket; and
a querying unit, configured to query, in the page index file, whether there is a value corresponding to the target key.

According to a third aspect, an embodiment of the present application provides an index query device based on a database. The device includes a memory, a processor, and a computer program stored in the memory and executable on the processor. The processor, when executing the computer program, implements the index query method based on a database.

According to a fourth aspect, an embodiment of the present application provides a computer-readable storage medium. The computer-readable storage medium stores instructions, and the instructions, when being run on a terminal device, cause the terminal device to perform the index query method based on a database.

### BRIEF DESCRIPTION OF THE DRAWINGS

FIG. 1 is a flowchart of an index query method based on a database according to an embodiment of the present application.

FIG. 2 is a schematic diagram of an overall architecture of an index in an embodiment of the present application.

FIG. 3 is a schematic diagram of a logical structure of a page index in an embodiment of the present application.

FIG. 4 is a schematic diagram of a physical structure of a page index in an embodiment of the present application.

FIG. 5 is a schematic diagram of a process of generating an initial chunk bitmap in an embodiment of the present application.

FIG. 6 is a schematic diagram of a process of generating a chunk bitmap in an embodiment of the present application.

FIG. 7 is a schematic diagram of a process of associating entry data with a chunk in an embodiment of the present application.

FIG. 8 is a schematic diagram of an index query apparatus according to an embodiment of the present application.

FIG. 9 is a schematic diagram of an electronic device according to an embodiment of the present application.

### DETAILED DESCRIPTION OF EMBODIMENTS

In order to make the above objects, features and advantages of the embodiments of the present application more comprehensible, the embodiments of the present application will be further described in detail below with reference to the drawings and specific implementations.

In order to facilitate understanding and explanation of the technical solution provided in the embodiments of the present application, the background art of the embodiments of the present application will be described below first.

In a (distributed) database, an index structure is crucial to a storage engine. Through an index, data that is not needed can be quickly filtered out, and target data is found, so that the query efficiency is improved.

In some scenarios, a read-only file will not be changed after being created. For example, for a database based on an LSM-Tree (Log-Structured Merge Tree), data is always written in an append mode, and the data is usually stored in a local disk or remote distributed file storage in a manner similar to an SSTable file. An SSTable file that has been created will not be modified, and new SSTable files are generated only through merging. This facilitates index design. The index only needs to be created with the read-only file and will not be modified. Therefore, in a query phase, an index structure to be loaded is read-only and does not need to support update operations such as addition and deletion.

In some scenarios, a read-only file will not be changed after being created. Therefore, in a query phase, an index structure to be loaded may be read-only, and does not need to support update operations such as addition and deletion. However, there is currently no mature solution for optimizing an index for a read-only scenario.

In practical applications, in a data query phase, data needs to be loaded into a memory, and calculation processing such as data filtering, aggregation and analysis is completed through a calculation engine. Because a process of loading data from an original storage medium into the memory has a relatively large delay and poor efficiency, a memory cache system is usually maintained inside the calculation engine. If data to be loaded already exists in the cache, the process of loading the data into the memory can be avoided, thereby improving calculation efficiency. In the cache system, a cache object is usually designed as a chunk/page (the size is usually at a KB or MB level) of original data. Correspondingly, data is loaded from a data file in units of pages, that is, one page is read from the file into the memory for use by the calculation engine every time. If the page exists in the cache, the page data in the cache can be directly used. Otherwise, the page is read from the file and placed in the cache system for a next query.

In order to adapt to such page organization, index data in a file also needs to be organized in the page manner. During index query, only some page index data of the index data needs to be loaded, and complete index data does not need to be loaded. In addition, after the page index data is obtained, the page index data needs to be parsed into an index object, and a query interface capability of the index is added, and then the index query can be performed. To ensure the query efficiency, the process of parsing the page index data needs to be sufficiently lightweight.

Based on this, in the index query method, apparatus, and device based on a database provided in the embodiments of the present application, index optimization for a read-only scenario is implemented, and the index structure can solve the following problems: providing an overall Key/Value search capability and ensuring an O(1) calculation complexity; loading an index on demand at a page granularity, and ensuring a lightweight parsing process; designing an efficient HashMap data structure that ensures relatively high space utilization and avoids space waste on the basis of ensuring O(1) search and lightweight parsing; designing a corresponding construction algorithm based on the structure; and designing a corresponding search algorithm based on the structure to ensure an O(1) calculation complexity.

In order to facilitate understanding of the embodiments of the present application, an index query method based on a database provided in an embodiment of the present application will be described below with reference to the drawings.

In view of this, embodiments of the present application provide an index query method, apparatus, and device based on a database, so as to optimize an index for a read-only scenario.

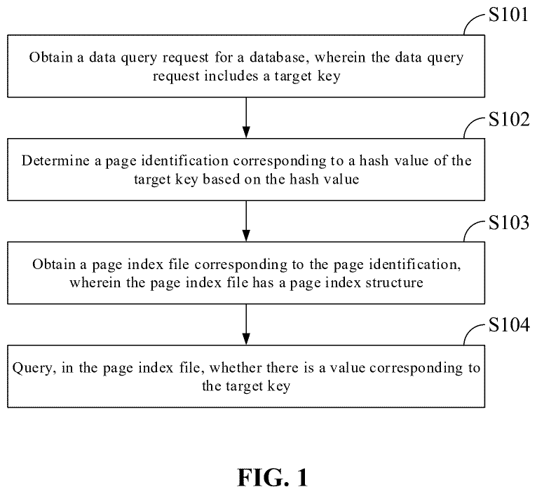

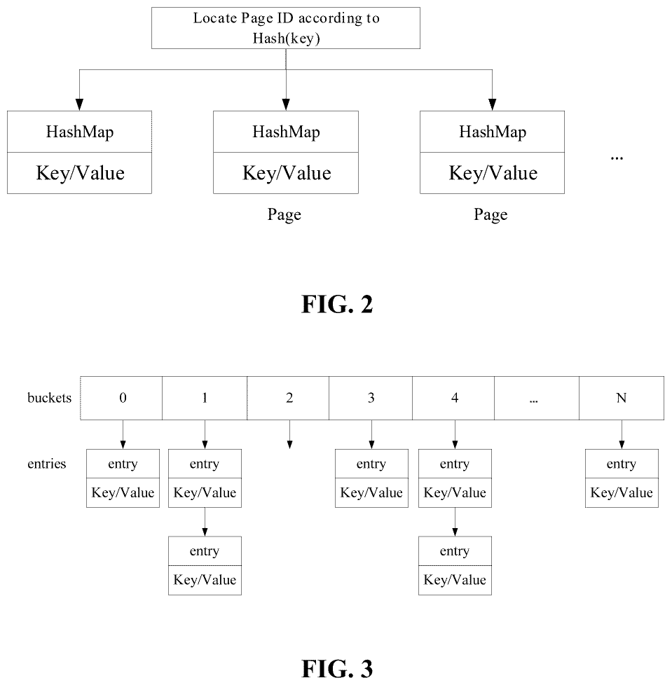

FIG. 1 is a flowchart of an index query method based on a database according to an embodiment of the present application. As shown in FIG. 2, the method may include S101 to S104.

S101: Obtain a data query request for a database, wherein the data query request includes a target key.

The embodiment of the present application may be applied to a storage engine, and the storage engine includes a database. When data query needs to be performed in the database, the storage engine may obtain the data query request for the database. The data query request includes a target key (target Key) for querying a value (Value) in the database corresponding to the target key.

S102: Determine a page identification corresponding to the target key based on a hash value of the target key.

During data query, data that is not needed can be quickly filtered out through an index, and target data is found. For example, a HashMap index is created in advance. A Key value of the HashMap index is a data value of a specific column of a data table, and a Value value of the HashMap index is a corresponding row number. When the index is queried, a needed data value is input as a target Key to query whether there is a corresponding row number. If there is a corresponding row number, the row number can be quickly output to obtain the value corresponding to the target Key.

Because the index may be divided into a plurality of page index files, the index may include a two-level index logically. FIG. 2 is a schematic diagram of the overall architecture of an index in an embodiment of the present application. A first-level index uses the number of pages in metadata (Meta). For any Key, the Key is divided into a corresponding lower-level page index file based on a hash value of the Key. The metadata is data for describing the index, and may include parameters such as the number of pages. A second-level index includes a plurality of physical page index files (Page), and each page includes an independent HashMap index.

The page identification (Page ID) corresponding to the target key is determined based on the hash value of the target key, so that an index is further queried in the page index file corresponding to the page identification, and a search scope is narrowed.

S103: Obtain the page index file corresponding to the page identification, wherein the page index file has a page index structure, the page index structure includes an entry array, a chunk bitmap and a length array, the entry array includes entry data of the page index file, the entry data is sorted in an order of buckets to which the entry data belong and in an order of the entry data in the buckets, each piece of the entry data includes a key-value pair of an index, the chunk bitmap includes a first field and a second field corresponding to each chunk, the first field is used to save, using a first preset number of bits, state values of whether buckets forming the chunk are empty buckets, the second field is used to save a first number value of pieces of entry data included in all chunks before a current chunk, the length array includes unary coding of non-empty buckets, and each piece of the unary coding corresponds to a number of pieces of entry data included in one non-empty bucket.

After the page identification of the target key is determined, the page index file corresponding to the page identification may be obtained. In practical applications, whether the page index file is in the memory may be determined first. If the page index file is not in the memory, the page index file is loaded into the memory. If the page index file is in the memory, the page index file is obtained from the memory. The page index file has a page index structure, and the page index structure is an index structure optimized according to a read-only scenario in the embodiments of the present application.

FIG. 3 is a schematic diagram of a logical structure of a page index in an embodiment of the present application. The page index file adopts a HashMap index, and the HashMap index adopts a chain (Separate Chaining) conflict solution logically. That is, Entry data in a same bucket (which may be empty) is organized in a logical chain and all Entry data in the bucket can be traversed sequentially. Each piece of Entry data is a Key-Value pair of an index.

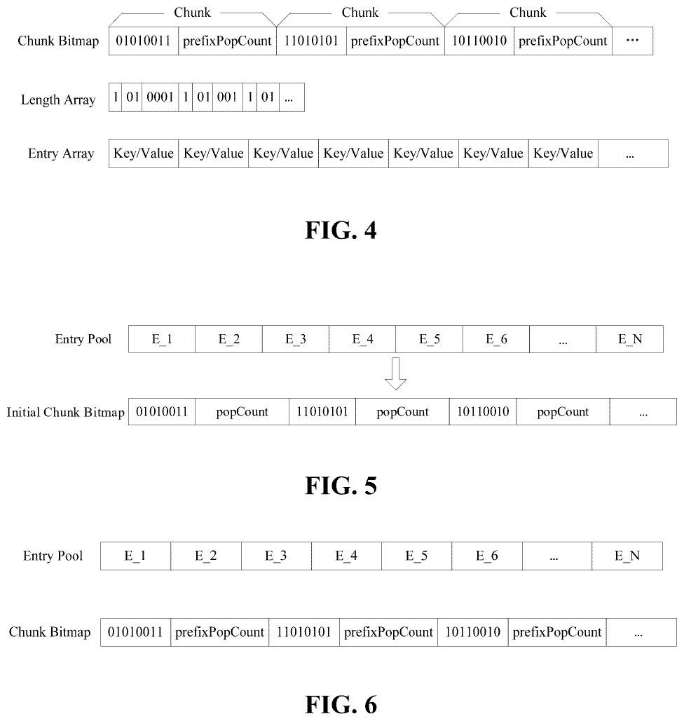

FIG. 4 is a schematic diagram of a physical structure of a page index in an embodiment of the present application. In the embodiment of the present application, the page index includes three parts in terms of a physical structure:

An Entry Array stores all Entry data, and each piece of Entry data is a Key/Value pair. Logically, the Entry data in a same bucket (chain) is physically stored in the Entry Array continuously in an order in the bucket. An order of the Entry data stored in different buckets (chains) is consistent with an order of the buckets (chains). That is, the Entry data in a former bucket is also located in a former part of the Entry Array.

Chunk Bitmap (chunk bitmap): A first preset number of N buckets form one chunk (Chunk). For example, the first preset number is 32, that is, every 32 buckets form one chunk. The chunk bitmap includes a first field and a second field corresponding to each chunk, and each field includes a first preset number of bits. That is, each chunk uses a first preset number of 2 times of bits to describe the chunk. The first field uses N bits to save state values of whether buckets forming the chunk are empty buckets, and the second field saves a first number value of pieces of entry data included in all chunks before a current chunk. The first field and the second field corresponding to each chunk are arranged continuously, and the chunks are arranged in an order of chunk identifications. For example, in the chunk bitmap, the chunk is described using a 64-bit word. The first 32 bits of the word are the first field, corresponding to state bitmaps of the 32 buckets in the chunk. A bit value (state value) of 1 represents that a bucket is not empty, and a bit value (state value) of 0 represents that a bucket is empty. In consideration of a conflict, there may be more than one piece of entry data in a bucket. The last 32 bits of the word are the second field, which is used as an integer prefixPopCount (first number value) of uint32, representing the total number of pieces of entry data in all former chunks. For example, if a first number value of a second chunk is 50, it represents that the total number of pieces of entry data in a first chunk is 50. In addition, FIG. 4 uses an example in which the first preset number is 8, and the first preset number may be set based on actual situations. The chunk bitmap includes a plurality of 64-bit words.

Length Array (length array) uses unary coding to describe a chain length of each non-empty bucket, that is, a number of pieces of Entry data included in the non-empty bucket. For example, 1 represents that the length is 1, 01 represents that the length is 2, 0001 represents that the length is 4, and so on. The entire length array is a flat storage representation of the unary coding of all non-empty buckets, and each piece of Entry data occupies 1 bit in the length array.

In terms of space occupation of the page index structure, it is assumed that the total number of pieces of Entry data is M, and a total space occupied by all Key/Value is S. Therefore, the number of bytes occupied by the entry array is S. It is assumed that a load factor is ¼. Therefore, there are 4*M buckets, the number of chunks is 4*M/32=M/8, and the number of bytes occupied by the entire chunk bitmap is M/8*8=M (one chunk occupies 8 bytes). Each piece of Entry data occupies 1 bit in the length array. Therefore, the number of bytes occupied by the entire length array is M/8. To sum up, space occupation of the entire page index structure is S+M+M/8=S+1.125M. That is, in addition to the space S that must be occupied, the HashMap index requires additional space of 1.125N bytes. In the case of a relatively low load factor, the occupied additional space is already very low data, thereby ensuring relatively high space utilization and avoiding space waste.

In addition, after the page index file is read from another storage medium into the memory, the page index object may be initialized only based on the memory address of the data and the total number of pieces of Entry data in the metadata. Therefore, the page index file may be loaded into the memory for use on demand at a page granularity without additional data parsing.

S104: Query, in the page index file, whether there is a value corresponding to the target key.

Whether there is a value corresponding to the target key is queried in the page index file. If there is a value corresponding to the target key, the value corresponding to the target key is further returned.

In the embodiments of the present application, an entire index file may be divided into a plurality of page index files. After a target key in a data query request for a database is obtained, a hash value of the target key is determined first to determine a page identification corresponding to the target key, so that a page index file corresponding to the page identification is determined. The page index file has a page index structure, and the page index structure is designed for a read-only scenario. The page index structure includes an entry array, a chunk bitmap, and a length array. The entry array stores entry data of the page index file continuously, and the entry data is sorted in an order of buckets to which the entry data belong and in an order of the entry data in the buckets. N buckets form one chunk, and the chunk bitmap includes a first field and a second field corresponding to each chunk. The first field includes N bits, and the N bits correspond to state values of whether the N buckets forming the chunk are empty buckets. The second field corresponds to a first number value of pieces of entry data included in all chunks before a current chunk. The length array stores unary coding of non-empty buckets continuously, and each piece of the unary coding corresponds to a number of pieces of entry data included in one non-empty bucket. Whether there is a value corresponding to the target key may be queried through the page index file. Because the page index structure is designed for the read-only scenario, storage therein is continuous, thereby ensuring relatively high space utilization. Moreover, the page index file can be directly loaded from another storage medium into a memory for use without additional data parsing. In this way, index optimization for the read-only scenario is implemented.

Based on the page index structure in the embodiments of the present application, a corresponding search algorithm is further provided. In a possible implementation, the specific implementation of querying, in the page index file, whether there is the value corresponding to the target key in S104 may include:

A1: Determine a bucket identification corresponding to the target key based on the hash value of the target key.

The bucket identification BID of the bucket where the target key is located may be calculated based on the hash value of the target key. The bucket identifications BID of the buckets are arranged in order. Specifically, it is assumed that the number of buckets is X, and the hash value of the target key may be modulo X to obtain the bucket identification BID.

A2: Determine a chunk identification corresponding to the bucket identification.

Because N buckets form one chunk (Chunk), the chunk identification Chunk ID may be obtained based on the bucket identification. Taking N as 32 as an example, BID/32 is rounded to obtain the chunk identification Chunk ID.

A3: Query, in the first field corresponding to the chunk identification in the chunk bitmap, whether the bucket corresponding to the bucket identification is empty.

The area corresponding to the chunk may be determined from the chunk bitmap based on the chunk identification Chunk ID, so that the N bits of the first field corresponding to the chunk and the first number value in the second field are obtained. In the N bits of the first field, the bit corresponding to the bucket identification may be obtained to determine whether the bucket is empty. For example, if Chunk ID is 0, the first field and the second field corresponding to the chunk are obtained from the first 64 bits of the chunk bitmap. Because this is the first chunk, the first number value in the second field is 0. Then the corresponding bit value (state value) is obtained based on the bucket identification.

A4: Return, in response to the bucket corresponding to the bucket identification being empty, that there is no value corresponding to the target key.

If the bit value is 0, it represents that the bucket corresponding to the bucket identification is empty, representing that there is no value corresponding to the target key, and the process returns directly.

A5: Determine, in response to the bucket corresponding to the bucket identification being not empty, a start position in the entry array and the number of entries of the bucket corresponding to the bucket identification based on the chunk bitmap and the length array.

If the bit value is 0, it represents that the bucket corresponding to the bucket identification is not empty, and the start position in the entry array and the number of entries of the bucket identification can be calculated.

In a possible implementation, the specific implementation of determining, in response to the bucket corresponding to the bucket identification being not empty, the start position in the entry array and the number of entries of the bucket corresponding to the bucket identification based on the chunk bitmap and the length array in A5, may include:

B1: in response to the bucket corresponding to the bucket identification being not empty, obtain the number of non-empty buckets before the bucket corresponding to the bucket identification in the first field corresponding to the chunk identification in the chunk bitmap, and record the number as a second number value, and obtain the first number value in the second field corresponding to the chunk identification in the chunk bitmap and record the first number value as a third number value.

If the bit value is 0, it represents that the bucket corresponding to the bucket identification is not empty. In the current chunk, the number of non-empty buckets before the bucket identification BID is the second number value B, and the second number value B is less than 32. The first number value prefixPopCount of the current chunk is taken as the third number value P.

B2: Read the second number of pieces of unary coding from a bit at a position obtained by adding 1 to the third number value in the length array, and accumulate the number of pieces of entry data corresponding to the second number of pieces of unary coding to obtain a fourth number value.

In the length array, B pieces of unary coding are read from the (P+1)th bit position, and the number of pieces of Entry data corresponding to the pieces of unary coding are accumulated, and the sum is recorded as the fourth number value S.

B3: Add the third number value to the fourth number value to obtain the start position of the bucket corresponding to the bucket identification in the entry array, and read the number of pieces of entry data corresponding to a next piece of unary coding as the number of entries.

The start subscript of the bucket (BID bucket chain) corresponding to the bucket identification in the entry array is P+S. In the length array, the next piece of unary coding is continued to be read, and the number of pieces of Entry data corresponding to the piece of unary coding is the number of pieces of Entry data (the number of entries) included in the bucket (BID bucket chain).

A6: Query, starting from the start position in the entry array, whether there is the value corresponding to the target key in the number of entries of pieces of entry data.

Keys of the pieces of Entry data in the chain in the bucket are sequentially read from the entry array based on the start subscript and the number of entries of the bucket (BID bucket chain) in the entry array. An equal-value judgment is performed between the Keys and the target Key. If the Keys are equal, the corresponding Value value is returned. If there is no Entry data with a same Key, the search fails, representing that there is no value corresponding to the target key in the index.

The complexity of the index search process is calculated: The bucket identification may be directly determined based on information such as the target Key and the hash value, and the corresponding chunk information is directly read from the chunk bitmap. Based on the bucket identification and the chunk information, at most B pieces of unary coding values (B<32) are read from the length array, and the start position and length information of the bucket chain may be calculated. This process is at a constant level and is independent of the number of entries. In the bucket chain, a matching Key value is searched for. On the premise that the hash function is balanced, the length of the chain (that is, the number of entries in one bucket) is limited. This is also a theoretical basis of all HashMap algorithms. The search complexity in the bucket chain is at a constant level, that is, the O(1) calculation complexity is ensured.

Therefore, based on the index structure in the embodiments of the present application, a corresponding index search algorithm can be implemented, and the overall calculation complexity of the index search algorithm is ensured to be O(1).

Based on the page index structure in the embodiments of the present application, a corresponding index structure construction algorithm is further provided. In a possible implementation, the index query method based on a database provided in the embodiment of the present application further includes:

C1: Determine a total data volume of key-value pairs of an entire index, and generate the number of pages based on the total data volume and a page size parameter.

In the embodiment of the present application, the entire two-level index may be created first, and then the page index file in the second-level index is created. All Key-Value of the entire index is collected to obtain all entry data. The overall data volume TotalSize of all entry data is calculated. A suitable number of pages Y is generated using TotalSize/PageSize based on expected PageSize (which may be predetermined as a parameter).

C2: Divide the entire index into a plurality of entry data sets based on hash values of keys in the key-value pairs of the index.

All entry data is traversed, and each piece of entry data is allocated to a specific page based on the hash value of the Key value of each piece of entry data and the number of pages. In this way, the entire index is divided into a plurality of entry data sets, and each entry data set corresponds to one page.

C3: Create a corresponding page index file for each entry data set.

For the entry data set of each page, the page index file provided in the embodiment of the present application is created.

The construction algorithm of the page index file is described below. In a possible implementation, the specific implementation of creating the corresponding page index file for each entry data set in C1 may include:

D1: Obtain a fifth number value of pieces of entry data in a target entry data set, and calculate a sixth number value of buckets in the page index structure based on the fifth number value, wherein the target entry data set is any of the entry data set.

For a specific entry data set, the total number of pieces of entry data included in the entry data set is recorded as the fifth number value. The number of buckets in the page may be obtained based on the load factor and recorded as the sixth number value.

D2: Construct a chunk bitmap based on hash values of keys of the entry data in the target entry data set, the sixth number value, and the first preset number.

The entry data set is traversed to calculate the hash values of the Key values of the pieces of entry data. Based on the hash values of the Key values and the sixth number value, it can be determined which bucket each piece of entry data is allocated to, thereby determining whether each bucket is empty. Every first preset number of buckets is divided into one chunk. Therefore, the chunk bitmap may be constructed based on the state values of whether the buckets are empty and the number of pieces of entry data included in each chunk.

In a possible implementation, the specific implementation of constructing the chunk bitmap based on the hash values of the keys of the entry data in the target entry data set, the sixth number value, and the first preset number in D2 may include:

E1: Determine, based on the hash values of the keys of the entry data in the target entry data set, entry data corresponding to each bucket, and determine state values of whether the buckets are empty.

Specifically, in the target entry data set, the hash values of the Key values of the pieces of Entry data are calculated. Based on the hash values and the sixth number value, it can be determined which bucket each piece of Entry data should belong to, and then whether each bucket is empty can be determined, so that the state values of whether the buckets are empty are obtained.

E2: Divide all the buckets into a plurality of chunks based on the sixth number value and the first preset number to generate an initial chunk bitmap, wherein the initial chunk bitmap includes a third field and a fourth field, the third field is used to save, using the first preset number of bits, state values of whether the buckets forming the chunk are empty buckets, and the fourth field is used to save a seventh number value of pieces of entry data included in the current chunk.

All the buckets in the target entry data set (Entry Pool) may be divided into a plurality of chunks based on the sixth number value (the total number of buckets) and the first preset number (the number of buckets in each chunk) to update the initial chunk bitmap. FIG. 5 is a schematic diagram of a process of generating an initial chunk bitmap in an embodiment of the present application. Similar to the foregoing description of the chunk bitmap, a first preset number of N buckets form one chunk (Chunk). For example, the first preset number is 32, that is, every 32 buckets form one chunk. The initial chunk bitmap includes a third field and a fourth field corresponding to each chunk, and each chunk uses a first preset number of 2 times of bits to describe the chunk. The third field uses N bits to save state values of whether the buckets forming the chunk are empty buckets, and the fourth field saves a seventh number value of pieces of entry data included in the current chunk. The third field and the fourth field corresponding to each chunk are arranged continuously, and the chunks are arranged in an order of chunk identifications. For example, the chunk is described using a 64-bit word. The first 32 bits of the word are the third field, corresponding to state bitmaps of the 32 buckets in the chunk. A bit value (state value) of 1 represents that a bucket is not empty, and a bit value (state value) of 0 represents that a bucket is empty. The last 32 bits of the word are the fourth field, which is used as an integer PopCount (seventh number value) of uint32, representing the total number of pieces of entry data in the current chunk. In addition, FIG. 5 uses an example in which the first preset number is 8, and the first preset number may be set based on actual situations.

E3: Generate the first number value of pieces of entry data included in all chunks before the current chunk based on the fourth field corresponding to each chunk in the initial chunk bitmap, to construct the chunk bitmap.

FIG. 6 is a schematic diagram of a process of generating a chunk bitmap in an embodiment of the present application. The PopCount (seventh number value) of each chunk in the initial fast bitmap is used, and the PopCount of each chunk is accumulated to generate the prefixPopCount of a next chunk. Then the third field in the initial chunk bitmap is used as the first field of the chunk bitmap to complete the construction of the chunk bitmap.

D3: Associate the entry data in the target entry data set with a corresponding chunk to generate an entry array and a length array.

Finally, the Entry data in the target entry data set may be associated with the corresponding chunk and bucket, to generate the Entry Array and the Length Array.

In a possible implementation, the specific implementation of associating the entry data in the target entry data set with the corresponding chunk to generate the entry array and the length array in D3 may include:

F1: Associate the entry data with the corresponding chunk based on the hash values of the keys of the entry data in the target entry data set.

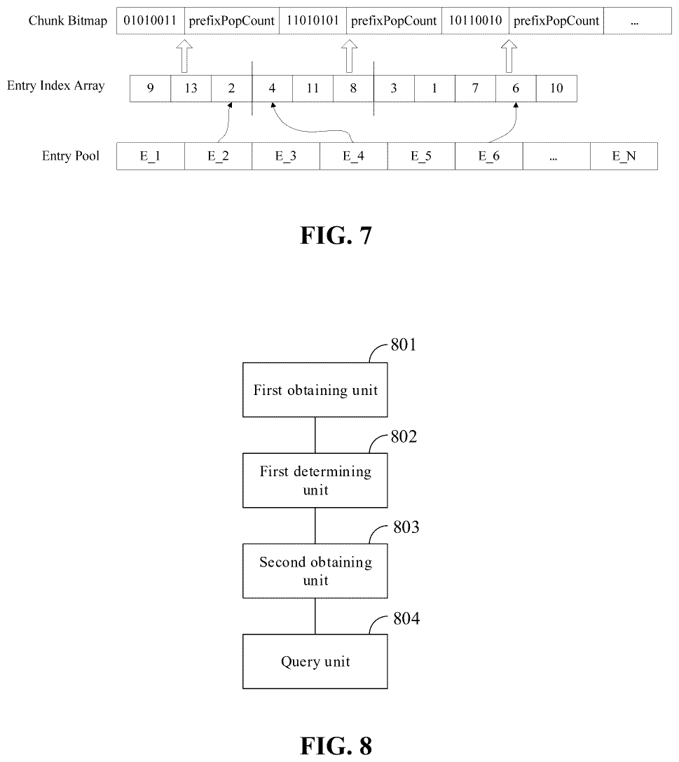

The hash values of the Keys of the Entry data in the target entry data set may be used to associate the Entry data with the corresponding chunk. FIG. 7 is a schematic diagram of a process of associating entry data with a chunk in an embodiment of the present application. In practical applications, the number of pieces of Entry data included in each chunk may be obtained based on the chunk bitmap, and an entry index array is created and used to save subscripts of the Entry data in each chunk. For example, the first chunk includes three pieces of Entry data, and the first three positions in the entry index array correspond to the first chunk. The second chunk includes three pieces of Entry data, and the next three positions in the entry index array correspond to the second chunk. The third chunk includes five pieces of Entry data, and the next five positions in the entry index array correspond to the third chunk. By analogy, the Entry data is traversed, and the Entry data is associated with the corresponding chunk based on the hash values of the Keys of the Entry data, that is, the subscript of the Entry data is written into a corresponding area of the entry index array of the corresponding chunk. For example, the second piece of Entry data belongs to the first chunk, and the subscript of the second piece of Entry data is written into the first three positions of the entry index array corresponding to the first chunk. In this way, the Entry data included in each chunk can be obtained, but the bucket corresponding to the Entry data in the chunk is not determined at this time.

F2: Traverse each chunk, and allocate, based on the hash values of the keys of the entry data in the chunk, corresponding entry data to each bucket.

For each chunk, the Entry data in the chunk is allocated to the corresponding bucket based on the hash values of the Keys of the Entry data.

F3: Write the entry data in each bucket into the entry array in sequence, and write, in a manner of the unary coding, the number of pieces of entry data included in the non-empty bucket into the length array.

The number of pieces of Entry data included in the non-empty bucket may be written into the length array in the manner of the unary coding, and the Entry data in the bucket is written into the entry array in sequence. In this way, the construction of the length array and the entry array is completed.

Based on the index structure in the embodiments of the present application, a corresponding index construction algorithm can be implemented.

Based on the index query method based on a database provided in the foregoing method embodiments, the embodiments of the present application further provide an index query apparatus based on a database. The apparatus is described below with reference to the drawings.

FIG. 8 is a schematic diagram of an index query apparatus based on a database according to an embodiment of the present application. As shown in FIG. 8, the index query apparatus based on a database includes:
a first obtaining unit 801, configured to obtain a data query request for a database, wherein the data query request includes a target key;
a first determining unit 802, configured to determine a page identification corresponding to the target key based on a hash value of the target key;
a second obtaining unit 803, configured to obtain a page index file corresponding to the page identification, wherein the page index file has a page index structure, the page index structure includes an entry array, a chunk bitmap and a length array, the entry array includes entry data of the page index file, the entry data is sorted in an order of buckets to which the entry data belong and in an order of the entry data in the buckets, each piece of the entry data includes a key-value pair of an index, the chunk bitmap includes a first field and a second field corresponding to each chunk, the first field is used to save, using a first preset number of bits, state values of whether buckets forming the chunk are empty buckets, the second field is used to save a first number value of pieces of entry data included in all chunks before a current chunk, the length array includes unary coding of non-empty buckets, and each piece of the unary coding corresponds to a number of pieces of entry data included in one non-empty bucket; and
a querying unit 804, configured to query, in the page index file, whether there is a value corresponding to the target key.

In a possible implementation, the querying unit includes:
a first determining subunit, configured to determine a bucket identification corresponding to the target key based on the hash value of the target key;
a second determining subunit, configured to determine a chunk identification corresponding to the bucket identification based on the bucket identification;
a first query subunit, configured to query, in the first field corresponding to the chunk identification in the chunk bitmap, whether the bucket corresponding to the bucket identification is empty;
a returning subunit, configured to return, in response to the bucket corresponding to the bucket identification being empty, that there is no value corresponding to the target key;
a third determining subunit, configured to determine, in response to the bucket corresponding to the bucket identification being not empty, a start position in the entry array and the number of entries of the bucket corresponding to the bucket identification based on the chunk bitmap and the length array; and
a second query subunit, configured to query, starting from the start position in the entry array, whether there is the value corresponding to the target key in the number of entries of pieces of entry data.

In a possible implementation, the third determining subunit is further configured to:
in response to the bucket corresponding to the bucket identification being not empty, obtain the number of non-empty buckets before the bucket corresponding to the bucket identification in the first field corresponding to the chunk identification in the chunk bitmap, and record the number as a second number value, and obtain the first number value in the second field corresponding to the chunk identification in the chunk bitmap and record the first number value as a third number value;
read the second number of pieces of unary coding from a bit at a position obtained by adding 1 to the third number value in the length array, and accumulate the number of pieces of entry data corresponding to the second number of pieces of unary coding to obtain a fourth number value; and
add the third number value to the fourth number value to obtain the start position of the bucket corresponding to the bucket identification in the entry array, and read the number of pieces of entry data corresponding to a next piece of unary coding as the number of entries.

In a possible implementation, the apparatus further includes:
a second determining unit, configured to determine a total data volume of key-value pairs of an entire index, and generate the number of pages based on the total data volume and a page size parameter;
a dividing unit, configured to divide the entire index into a plurality of entry data sets based on hash values of keys in the key-value pairs of the index; and
an establishing unit, configured to create a corresponding page index file for each entry data set.

In a possible implementation, the establishing unit includes:
an obtaining subunit, configured to obtain a fifth number value of pieces of entry data in a target entry data set, and calculate a sixth number value of buckets in the page index structure based on the fifth number value, wherein the target entry data set is any of the entry data set;
a constructing subunit, configured to construct a chunk bitmap based on hash values of keys of the entry data in the target entry data set, the sixth number value, and a first preset number; and
a generating subunit, configured to associate the entry data in the target entry data set with a corresponding chunk to generate an entry array and a length array.

In a possible implementation, the constructing subunit is further configured to:
determine, based on the hash values of the keys of the entry data in the target entry data set, entry data corresponding to each bucket, and determine state values of whether the buckets are empty;
divide all the buckets into a plurality of chunks based on the sixth number value and the first preset number to generate an initial chunk bitmap, wherein the initial chunk bitmap includes a third field and a fourth field, the third field is used to save, using the first preset number of bits, state values of whether the buckets forming the chunk are empty buckets, and the fourth field is used to save a seventh number value of pieces of entry data included in the current chunk; and
generate the first number value of pieces of entry data included in all chunks before the current chunk based on the fourth field corresponding to each chunk in the initial chunk bitmap, to construct the chunk bitmap.

In a possible implementation, the generating subunit is further configured to:
associate the entry data with the corresponding chunk based on the hash values of the keys of the entry data in the target entry data set;
traverse each chunk, and allocate, based on the hash values of the keys of the entry data in the chunk, corresponding entry data to each bucket; and
write the entry data in each bucket into the entry array in sequence, and write, in a manner of the unary coding, the number of pieces of entry data included in the non-empty bucket into the length array.

In addition, an embodiment of the present application further provides a computer program product. The computer program product includes computer program instructions, and the computer program instructions, when being run on a computer, cause the computer to perform the index query method based on a database.

In the embodiments of the present application, an entire index file may be divided into a plurality of page index files. After a target key in a data query request for a database is obtained, a hash value of the target key is determined first to determine a page identification corresponding to the target key, so that a page index file corresponding to the page identification is determined. The page index file has a page index structure, and the page index structure is designed for a read-only scenario. The page index structure includes an entry array, a chunk bitmap, and a length array. The entry array stores entry data of the page index file continuously, and the entry data is sorted in an order of buckets to which the entry data belong and in an order of the entry data in the buckets. N buckets form one chunk, and the chunk bitmap includes a first field and a second field corresponding to each chunk. The first field includes N bits, and the N bits correspond to state values of whether the N buckets forming the chunk are empty buckets. The second field corresponds to a first number value of pieces of entry data included in all chunks before a current chunk. The length array stores unary coding of non-empty buckets continuously, and each piece of the unary coding corresponds to a number of pieces of entry data included in one non-empty bucket. Whether there is a value corresponding to the target key may be queried through the page index file. Because the page index structure is designed for the read-only scenario, storage therein is continuous, thereby ensuring relatively high space utilization. Moreover, the page index file can be directly loaded from another storage medium into a memory for use without additional data parsing. In this way, index optimization for the read-only scenario is implemented.

It can be seen that the embodiments of the present application have the following beneficial effects:

In the embodiments of the present application, an entire index file may be divided into a plurality of page index files. After a target key in a data query request for a database is obtained, a hash value of the target key is determined first to determine a page identification corresponding to the target key, so that a page index file corresponding to the page identification is determined. The page index file has a page index structure, and the page index structure is designed for a read-only scenario. The page index structure includes an entry array, a chunk bitmap, and a length array. The entry array stores entry data of the page index file continuously, and the entry data is sorted in an order of buckets to which the entry data belong and in an order of the entry data in the buckets. N buckets form one chunk, and the chunk bitmap includes a first field and a second field corresponding to each chunk. The first field includes N bits, and the N bits correspond to state values of whether the N buckets forming the chunk are empty buckets. The second field corresponds to a first number value of pieces of entry data included in all chunks before a current chunk. The length array stores unary coding of non-empty buckets continuously, and each piece of the unary coding corresponds to a number of pieces of entry data included in one non-empty bucket. Whether there is a value corresponding to the target key may be queried through the page index file. Because the page index structure is designed for the read-only scenario, storage therein is continuous, thereby ensuring relatively high space utilization. Moreover, the page index file can be directly loaded from another storage medium into a memory for use without additional data parsing. In this way, index optimization for the read-only scenario is implemented.

Based on the index query method based on a database provided in the foregoing method embodiments, the present application further provides an electronic device. The electronic device includes one or more processors and a storage apparatus. The storage apparatus stores one or more programs, and the one or more programs, when being executed by the one or more processors, cause the one or more processors to implement the index query method based on a database.

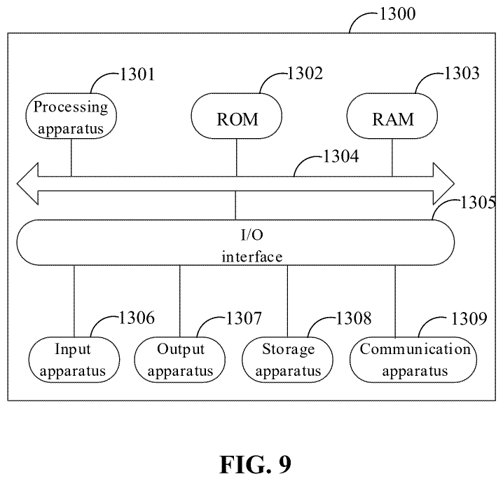

Reference is made to FIG. 9 below, which illustrates a schematic structural diagram of an electronic device 1300 suitable for implementing the embodiments of the present application. The terminal device in the embodiments of the present application may include, but is not limited to, a mobile terminal such as a mobile phone, a laptop, a digital broadcast receiver, a personal digital assistant (PDA), a tablet computer, a portable media player (PMP), and an in-vehicle terminal (such as an in-vehicle navigation terminal), and a fixed terminal such as a digital TV (television) and a desktop computer. The electronic device shown in FIG. 9 is merely an example and should not impose any limitation on the function and scope of use of the embodiments of the present application.

As shown in FIG. 9, the electronic device 1300 may include a processing apparatus 1301 (such as a central processing unit and a graphics processing unit). The processing apparatus 1301 may perform various appropriate actions and processing according to a program stored in a read-only memory (ROM) 1302 or a program loaded from a storage apparatus 1306 into a random-access memory (RAM) 1303. The RAM 1303 further stores various programs and data required for the operation of the electronic device 1300. The processing apparatus 1301, the ROM 1302, and the RAM 1303 are connected to each other through a bus 1304. An input/output (I/O) interface 1305 is also connected to the bus 1304.

Generally, the following apparatuses may be connected to the I/O interface 1305: an input apparatus 1306 such as a touch screen, a touchpad, a keyboard, a mouse, a camera, a microphone, an accelerometer, and a gyroscope; an output apparatus 1307 such as a liquid crystal display (LCD), a speaker, and a vibrator; the storage apparatus 1306 such as a magnetic tape and a hard disk; and a communication apparatus 1309. The communication apparatus 1309 may allow the electronic device 1300 to be in wireless or wired communication with other devices to exchange data. Although FIG. 9 shows the electronic device 1300 having various apparatuses, it should be understood that not all of the illustrated apparatuses need to be implemented or provided. Alternatively, more or fewer apparatuses may be implemented or provided.

Particularly, according to the embodiments of the present application, the process described above with reference to the flowchart may be implemented as a computer software program. For example, an embodiment of the present application includes a computer program product, which includes a computer program carried on a non-transitory computer-readable medium. The computer program includes program codes for executing the method shown in the flowchart. In such an embodiment, the computer program may be downloaded from a network through the communication apparatus 1309 and installed, or may be installed from the storage apparatus 1306, or may be installed from the ROM 1302. When the computer program is executed by the processing apparatus 1301, the above functions defined in the method of the embodiments of the present application are executed.

The electronic device provided in the embodiment of the present application belongs to the same inventive concept as the index query method based on a database provided in the foregoing embodiments. For the technical details not described in detail in this embodiment, reference may be made to the foregoing embodiments, and this embodiment has the same beneficial effects as the foregoing embodiments.

Based on the index query method based on a database provided in the foregoing method embodiments, an embodiment of the present application provides a computer-readable medium. The computer-readable medium stores a computer program, and the program, when being executed by a processor, implements the index query method based on a database.

It should be noted that the computer-readable medium in the embodiments of the present application may be a computer-readable signal medium or a computer-readable storage medium, or any combination thereof. The computer-readable storage medium may be, for example, but not limited to, an electrical, magnetic, optical, electromagnetic, infrared, or semiconductor system, apparatus, or device, or any combination thereof. More specific examples of the computer-readable storage medium may include, but are not limited to, an electrical connection with one or more wires, a portable computer magnetic disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof. In the embodiments of the present application, the computer-readable storage medium may be any tangible medium that contains or stores a program. The program may be used by or in combination with an instruction execution system, apparatus, or device. In the embodiments of the present application, the computer-readable signal medium may include a data signal that propagates in a baseband or as part of a carrier and carries computer-readable program codes. This propagated data signal may take many forms, including but not limited to an electromagnetic signal, an optical signal, or any suitable combination thereof. The computer-readable signal medium may also be any computer-readable medium other than the computer-readable storage medium. The computer-readable signal medium may send, propagate, or transmit a program used by or in combination with an instruction execution system, apparatus, or device. The program codes contained on the computer-readable medium may be transmitted using any suitable medium, including but not limited to an electric wire, an optical cable, radio frequency (RF), or any suitable combination thereof.

In some implementations, clients and servers may communicate using any currently known or future developed network protocol such as the Hypertext transfer protocol (HTTP), and may be interconnected with any form or medium of digital data communication (for example, a communication network). Examples of the communication network include a local area network (“LAN”), a wide area network (“WAN”), an internet (for example, the Internet), a peer-to-peer network (for example, an ad hoc peer-to-peer network), and any currently known or future developed network.

The computer-readable medium may be included in the electronic device, or may exist alone without being assembled into the electronic device.

The computer-readable medium carries one or more programs, and the one or more programs, when being executed by the electronic device, cause the electronic device to perform the index query method based on a database.

The computer program codes for performing the operations in the embodiments of the present application may be written in one or more programming languages or a combination thereof. The foregoing programming languages include but are not limited to object-oriented programming languages such as Java, Smalltalk, and C++, and further include conventional procedural programming languages such as C or similar programming languages. The program code may be executed entirely on a computer of a user, executed partly on a computer of a user, executed as a stand-alone software package, executed partly on a computer of a user and partly on a remote computer, or executed entirely on a remote computer or a server. In the scenario related to the remote computer, the remote computer may be connected to the computer of the user through any type of network, including a local area network (LAN) or a wide area network (WAN), or the connection may be made to an external computer (for example, through the Internet using an Internet service provider).

The flowcharts and chunk diagrams in the drawings illustrate possible architecture, functions, and operations of the system, method, and computer program product according to various embodiments of the present application. In this regard, each chunk in the flowchart or chunk diagram may represent a module, a program segment, or a part of codes. The module, program segment, or part of codes contains one or more executable instructions for implementing specified logical functions. It should also be noted that in some alternative implementations, the functions marked in the chunks may also be implemented in an order different from those marked in the drawings. For example, two chunks shown in succession may, in fact, be executed substantially concurrently, or the two chunks may sometimes be executed in a reverse order, depending on the functions involved. It should also be noted that each chunk in the chunk diagram and/or flowchart and a combination of chunks in the chunk diagram and/or flowchart may be implemented by a dedicated hardware-based system that performs specified functions or operations, or may also be implemented by a combination of dedicated hardware and computer instructions.

The units involved in the embodiments of the present application may be implemented in software or hardware. The name of a unit/module does not constitute a limitation on the unit itself under certain circumstances.

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the embodiments of the present application, a machine-readable medium may be a tangible medium that may contain or store a program for use by or in combination with an instruction execution system, apparatus or device. The machine-readable medium may be a machine-readable signal medium or a machine-readable storage medium. The machine-readable medium may include, but is not limited to, an electrical, magnetic, optical, electromagnetic, infrared, or semiconductor system, apparatus or device, or any suitable combination of the foregoing. More specific examples of the machine-readable storage medium may include an electrical connection with one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the foregoing.

It should be noted that the embodiments of the present application are described in a progressive manner, and each embodiment focuses on differences from other embodiments, and the same or similar parts between the embodiments may refer to each other. For the system or apparatus disclosed in the embodiments, since they correspond to the methods disclosed in the embodiments, the description thereof is relatively simple, and reference may be made to the description of the methods for related parts.

It should be understood that in the present application, “at least one” refers to one or more, and “a plurality of” refers to two or more. “And/or” is used to describe an association relationship between associated objects, indicating that three relationships may exist. For example, “A and/or B” may represent the following three cases: only A exists, only B exists, and both A and B exist, wherein A and B may be singular or plural. The character “/” generally represents an “or” relationship between associated objects. “At least one of the following” or similar expressions refer to any combination of these items, including any combination of a single item (one) or a plurality of items (ones). For example, at least one of a, b, or c may represent: a, b, c, “a and b”, “a and c”, “b and c”, or “a and b and c”, wherein a, b, and c may be singular or plural.

It should also be noted that in the present application, relational terms such as first and second are merely intended to distinguish one entity or operation from another entity or operation, and do not necessarily require or imply that any such actual relationship or order exists between these entities or operations. Moreover, the term “include/comprise” or any other variation thereof is intended to cover a non-exclusive inclusion, such that a process, method, article, or device that includes a list of elements not only includes those elements but also includes other elements not expressly listed or inherent to such a process, method, article, or device. Without more limitations, an element defined by the statement “include/comprise one . . . ” does not exclude that there are other same elements in the process, method, article, or device that includes the element.

The steps of the method or algorithm described in conjunction with the embodiments disclosed herein may be implemented directly in hardware, a software module executed by a processor, or a combination thereof. The software module may be placed in a random access memory (RAM), a memory, a read-only memory (ROM), an electrically programmable ROM, an electrically erasable programmable ROM, a register, a hard disk, a removable magnetic disk, a CD-ROM, or any other form of storage medium well-known in the art.

The above description of the disclosed embodiments enables those skilled in the art to implement or use the present application. Various modifications to these embodiments will be readily apparent to those skilled in the art, and the general principles defined herein may be implemented in other embodiments without departing from the spirit or scope of the present application. Therefore, the present application will not be limited to these embodiments shown herein, but is to be accorded the widest scope consistent with the principles and novel features disclosed herein.

I/We claim:

1. An index query method based on a database, comprising:
obtaining a data query request for a database, wherein the data query request comprises a target key;
determining a page identification corresponding to the target key based on a hash value of the target key;
obtaining a page index file corresponding to the page identification, wherein the page index file has a page index structure, the page index structure comprises an entry array, a chunk bitmap and a length array, the entry array comprises entry data of the page index file, the entry data is sorted in an order of buckets to which the entry data belong and in an order of the entry data in the buckets, each piece of the entry data comprises a key-value pair of an index, the chunk bitmap comprises a first field and a second field corresponding to each chunk, the first field is used to save, using a first preset number of bits, state values of whether buckets forming the chunk are empty buckets, the second field is used to save a first number value of pieces of entry data comprised in all chunks before a current chunk, the length array comprises unary coding of non-empty buckets, and each piece of the unary coding corresponds to a number of pieces of entry data comprised in one non-empty bucket; and
querying, in the page index file, whether there is a value corresponding to the target key.

2. The method according to claim 1, wherein querying, in the page index file, whether there is the value corresponding to the target key comprises:
determining a bucket identification corresponding to the target key based on the hash value of the target key;
determining a chunk identification corresponding to the bucket identification based on the bucket identification;
querying, in the first field corresponding to the chunk identification in the chunk bitmap, whether the bucket corresponding to the bucket identification is empty;
returning, in response to the bucket corresponding to the bucket identification being empty, that there is no value corresponding to the target key;
determining, in response to the bucket corresponding to the bucket identification being not empty, a start position in the entry array and a number of entries of the bucket corresponding to the bucket identification based on the chunk bitmap and the length array; and
querying, starting from the start position in the entry array, whether there is the value corresponding to the target key in the number of entries of pieces of entry data.

3. The method according to claim 2, wherein determining, in response to the bucket corresponding to the bucket identification being not empty, the start position in the entry array and the number of entries of the bucket corresponding to the bucket identification based on the chunk bitmap and the length array comprises:
in response to the bucket corresponding to the bucket identification being not empty, obtaining the number of non-empty buckets before the bucket corresponding to the bucket identification in the first field corresponding to the chunk identification in the chunk bitmap and recording the number as a second number value, and obtaining the first number value in the second field corresponding to the chunk identification in the chunk bitmap and recording the first number value as a third number value;
reading the second number of pieces of unary coding from a bit at a position obtained by adding 1 to the third number value in the length array, and accumulating the number of pieces of entry data corresponding to the second number of pieces of unary coding to obtain a fourth number value; and
adding the third number value to the fourth number value to obtain the start position of the bucket corresponding to the bucket identification in the entry array, and reading the number of pieces of entry data corresponding to a next piece of unary coding as the number of entries.

4. The method according to claim 1, further comprising:
determining a total data volume of key-value pairs of an entire index, and generating a number of pages based on the total data volume and a page size parameter;
dividing the entire index into a plurality of entry data sets based on hash values of keys in the key-value pairs of the index; and
creating a corresponding page index file for each entry data set.

5. The method according to claim 4, wherein creating the corresponding page index file for each entry data set comprises:
obtaining a fifth number value of pieces of entry data in a target entry data set, and calculating a sixth number value of buckets in the page index structure based on the fifth number value, wherein the target entry data set is any of the entry data set;
constructing a chunk bitmap based on hash values of keys of the entry data in the target entry data set, the sixth number value, and a first preset number; and
associating the entry data in the target entry data set with a corresponding chunk to generate an entry array and a length array.

6. The method according to claim 5, wherein constructing the chunk bitmap based on the hash values of the keys of the entry data in the target entry data set, the sixth number value, and the first preset number comprises:
determining, based on the hash values of the keys of the entry data in the target entry data set, entry data corresponding to each bucket, and determining state values of whether the buckets are empty;
dividing all the buckets into a plurality of chunks based on the sixth number value and the first preset number to generate an initial chunk bitmap, wherein the initial chunk bitmap comprises a third field and a fourth field corresponding to each chunk, the third field is used to save, using the first preset number of bits, state values of whether the buckets forming the chunk are empty buckets, and the fourth field is used to save a seventh number value of pieces of entry data comprised in the current chunk; and
generating the first number value of pieces of entry data comprised in all chunks before the current chunk based on the fourth field corresponding to each chunk in the initial chunk bitmap, to construct the chunk bitmap.

7. The method according to claim 5, wherein associating the entry data in the target entry data set with the corresponding chunk to generate the entry array and the length array comprises:
associating the entry data with the corresponding chunk based on the hash values of the keys of the entry data in the target entry data set;
traversing each chunk, and allocating, based on the hash values of the keys of the entry data in the chunk, corresponding entry data to each bucket; and
writing the entry data in each bucket into the entry array in sequence, and writing, in a manner of the unary coding, the number of pieces of entry data comprised in the non-empty bucket into the length array.

8. An index query device based on a database, comprising: a memory, a processor, and a computer program stored on the memory and executable on the processor, wherein the processor, when executing the computer program, implements an index query method based on a database comprising:
obtaining a data query request for a database, wherein the data query request comprises a target key;
determining a page identification corresponding to the target key based on a hash value of the target key;
obtaining a page index file corresponding to the page identification, wherein the page index file has a page index structure, the page index structure comprises an entry array, a chunk bitmap and a length array, the entry array comprises entry data of the page index file, the entry data is sorted in an order of buckets to which the entry data belong and in an order of the entry data in the buckets, each piece of the entry data comprises a key-value pair of an index, the chunk bitmap comprises a first field and a second field corresponding to each chunk, the first field is used to save, using a first preset number of bits, state values of whether buckets forming the chunk are empty buckets, the second field is used to save a first number value of pieces of entry data comprised in all chunks before a current chunk, the length array comprises unary coding of non-empty buckets, and each piece of the unary coding corresponds to a number of pieces of entry data comprised in one non-empty bucket; and
querying, in the page index file, whether there is a value corresponding to the target key.

9. The chunk according to claim 8, wherein querying, in the page index file, whether there is the value corresponding to the target key comprises:
determining a bucket identification corresponding to the target key based on the hash value of the target key;
determining a chunk identification corresponding to the bucket identification based on the bucket identification;
querying, in the first field corresponding to the chunk identification in the chunk bitmap, whether the bucket corresponding to the bucket identification is empty;
returning, in response to the bucket corresponding to the bucket identification being empty, that there is no value corresponding to the target key;
determining, in response to the bucket corresponding to the bucket identification being not empty, a start position in the entry array and a number of entries of the bucket corresponding to the bucket identification based on the chunk bitmap and the length array; and
querying, starting from the start position in the entry array, whether there is the value corresponding to the target key in the number of entries of pieces of entry data.

10. The chunk according to claim 9, wherein determining, in response to the bucket corresponding to the bucket identification being not empty, the start position in the entry array and the number of entries of the bucket corresponding to the bucket identification based on the chunk bitmap and the length array comprises:
in response to the bucket corresponding to the bucket identification being not empty, obtaining the number of non-empty buckets before the bucket corresponding to the bucket identification in the first field corresponding to the chunk identification in the chunk bitmap and recording the number as a second number value, and obtaining the first number value in the second field corresponding to the chunk identification in the chunk bitmap and recording the first number value as a third number value;
reading the second number of pieces of unary coding from a bit at a position obtained by adding 1 to the third number value in the length array, and accumulating the number of pieces of entry data corresponding to the second number of pieces of unary coding to obtain a fourth number value; and
adding the third number value to the fourth number value to obtain the start position of the bucket corresponding to the bucket identification in the entry array, and reading the number of pieces of entry data corresponding to a next piece of unary coding as the number of entries.

11. The chunk according to claim 8, wherein the index query method further comprises:
determining a total data volume of key-value pairs of an entire index, and generating a number of pages based on the total data volume and a page size parameter;
dividing the entire index into a plurality of entry data sets based on hash values of keys in the key-value pairs of the index; and
creating a corresponding page index file for each entry data set.

12. The chunk according to claim 11, wherein creating the corresponding page index file for each entry data set comprises:
obtaining a fifth number value of pieces of entry data in a target entry data set, and calculating a sixth number value of buckets in the page index structure based on the fifth number value, wherein the target entry data set is any of the entry data set;
constructing a chunk bitmap based on hash values of keys of the entry data in the target entry data set, the sixth number value, and a first preset number; and
associating the entry data in the target entry data set with a corresponding chunk to generate an entry array and a length array.

13. The chunk according to claim 12, wherein constructing the chunk bitmap based on the hash values of the keys of the entry data in the target entry data set, the sixth number value, and the first preset number comprises:
determining, based on the hash values of the keys of the entry data in the target entry data set, entry data corresponding to each bucket, and determining state values of whether the buckets are empty;
dividing all the buckets into a plurality of chunks based on the sixth number value and the first preset number to generate an initial chunk bitmap, wherein the initial chunk bitmap comprises a third field and a fourth field corresponding to each chunk, the third field is used to save, using the first preset number of bits, state values of whether the buckets forming the chunk are empty buckets, and the fourth field is used to save a seventh number value of pieces of entry data comprised in the current chunk; and
generating the first number value of pieces of entry data comprised in all chunks before the current chunk based on the fourth field corresponding to each chunk in the initial chunk bitmap, to construct the chunk bitmap.

14. The chunk according to claim 12, wherein associating the entry data in the target entry data set with the corresponding chunk to generate the entry array and the length array comprises:
associating the entry data with the corresponding chunk based on the hash values of the keys of the entry data in the target entry data set;
traversing each chunk, and allocating, based on the hash values of the keys of the entry data in the chunk, corresponding entry data to each bucket; and
writing the entry data in each bucket into the entry array in sequence, and writing, in a manner of the unary coding, the number of pieces of entry data comprised in the non-empty bucket into the length array.

15. A non-transitory computer-readable storage medium storing instructions, wherein the instructions, when executed on a terminal device, cause the terminal device to perform an index query method based on a database comprising:
obtaining a data query request for a database, wherein the data query request comprises a target key;
determining a page identification corresponding to the target key based on a hash value of the target key;
obtaining a page index file corresponding to the page identification, wherein the page index file has a page index structure, the page index structure comprises an entry array, a chunk bitmap and a length array, the entry array comprises entry data of the page index file, the entry data is sorted in an order of buckets to which the entry data belong and in an order of the entry data in the buckets, each piece of the entry data comprises a key-value pair of an index, the chunk bitmap comprises a first field and a second field corresponding to each chunk, the first field is used to save, using a first preset number of bits, state values of whether buckets forming the chunk are empty buckets, the second field is used to save a first number value of pieces of entry data comprised in all chunks before a current chunk, the length array comprises unary coding of non-empty buckets, and each piece of the unary coding corresponds to a number of pieces of entry data comprised in one non-empty bucket; and
querying, in the page index file, whether there is a value corresponding to the target key.

16. The non-transitory computer-readable storage medium according to claim 15, wherein querying, in the page index file, whether there is the value corresponding to the target key comprises:
determining a bucket identification corresponding to the target key based on the hash value of the target key;
determining a chunk identification corresponding to the bucket identification based on the bucket identification;
querying, in the first field corresponding to the chunk identification in the chunk bitmap, whether the bucket corresponding to the bucket identification is empty;
returning, in response to the bucket corresponding to the bucket identification being empty, that there is no value corresponding to the target key;
determining, in response to the bucket corresponding to the bucket identification being not empty, a start position in the entry array and a number of entries of the bucket corresponding to the bucket identification based on the chunk bitmap and the length array; and
querying, starting from the start position in the entry array, whether there is the value corresponding to the target key in the number of entries of pieces of entry data.

17. The non-transitory computer-readable storage medium according to claim 16, wherein determining, in response to the bucket corresponding to the bucket identification being not empty, the start position in the entry array and the number of entries of the bucket corresponding to the bucket identification based on the chunk bitmap and the length array comprises:
in response to the bucket corresponding to the bucket identification being not empty, obtaining the number of non-empty buckets before the bucket corresponding to the bucket identification in the first field corresponding to the chunk identification in the chunk bitmap and recording the number as a second number value, and obtaining the first number value in the second field corresponding to the chunk identification in the chunk bitmap and recording the first number value as a third number value;
reading the second number of pieces of unary coding from a bit at a position obtained by adding 1 to the third number value in the length array, and accumulating the number of pieces of entry data corresponding to the second number of pieces of unary coding to obtain a fourth number value; and
adding the third number value to the fourth number value to obtain the start position of the bucket corresponding to the bucket identification in the entry array, and reading the number of pieces of entry data corresponding to a next piece of unary coding as the number of entries.

18. The non-transitory computer-readable storage medium according to claim 15, wherein the index query method further comprises:
determining a total data volume of key-value pairs of an entire index, and generating a number of pages based on the total data volume and a page size parameter;
dividing the entire index into a plurality of entry data sets based on hash values of keys in the key-value pairs of the index; and
creating a corresponding page index file for each entry data set.

19. The non-transitory computer-readable storage medium according to claim 18, wherein creating the corresponding page index file for each entry data set comprises:
obtaining a fifth number value of pieces of entry data in a target entry data set, and calculating a sixth number value of buckets in the page index structure based on the fifth number value, wherein the target entry data set is any of the entry data set;
constructing a chunk bitmap based on hash values of keys of the entry data in the target entry data set, the sixth number value, and a first preset number; and
associating the entry data in the target entry data set with a corresponding chunk to generate an entry array and a length array.

20. The non-transitory computer-readable storage medium according to claim 19, wherein constructing the chunk bitmap based on the hash values of the keys of the entry data in the target entry data set, the sixth number value, and the first preset number comprises:
determining, based on the hash values of the keys of the entry data in the target entry data set, entry data corresponding to each bucket, and determining state values of whether the buckets are empty;
dividing all the buckets into a plurality of chunks based on the sixth number value and the first preset number to generate an initial chunk bitmap, wherein the initial chunk bitmap comprises a third field and a fourth field corresponding to each chunk, the third field is used to save, using the first preset number of bits, state values of whether the buckets forming the chunk are empty buckets, and the fourth field is used to save a seventh number value of pieces of entry data comprised in the current chunk; and
generating the first number value of pieces of entry data comprised in all chunks before the current chunk based on the fourth field corresponding to each chunk in the initial chunk bitmap, to construct the chunk bitmap.
